(19) United States
(12) Patent Application Publication
(10) Pub. No.: US 2005/0231982 A1
(43) Pub. Date: Oct. 20, 2005

(54) Light-guidance plate for liquid crystal display

(76) Inventor: Nobutaka Kajiura, Abiko-Shi (JP)

Correspondence Address: DELLETT AND WALTERS, P. O. BOX 2786, PORTLAND, OR, 97208-2786, US

(21) Appl. No.: 11/070,840

(22) Filed: Mar. 1, 2005

(30) Foreign Application Priority Data
Apr. 14, 2004 (JP) 2004-118630

(51) Int. Cl. F21V 7/04

(52) U.S. Cl. 362/625

(57) ABSTRACT

The invention relates to a light-guidance plate for liquid crystal display backlights, which ensures frontally symmetric, bright illumination over a wide field angle. The light-guidance plate 1 used for a liquid crystal display backlight comprises a transparent plate substrate having a front surface 11, a back surface 12 and an end face 15 for introduction therein of illumination light from a light source. The back surface 12 is provided with V-grooves 21 of V shape in section or quadrangular cone grooves 21′, each comprising slants 20 and 20 having an angle of ±(45°±5°) with respect to a center plane 1′ including the center of the entrance end 15 and parallel with the plane of the plate substrate, and a direct-reflection layer 30 is provided on each slant.

### BACKGROUND OF THE INVENTION

The present invention relates generally to a light-guidance plate for liquid crystal display backlights, and more particularly to a light-guidance plate for backlights that ensures bright illumination for wide-field-angle liquid crystal displays.

In a prior art backlight guidance plate designed to illuminate a transmission type liquid crystal display from its back surface, V-grooves of V shape in section or grooves of concave quadrangular cone shape are provided in the back surface of the guidance plate, so that light is guided by total reflection at slants thereof toward the front surface side of the guidance plate, leaving that guidance plate (for instance, patent publications 1 and 2).

Patent Publication 1

JP(A)10-20125

Patent Publication 2

JP (A) 11-286558

In this context, a backlight guidance plate is usually a thin plate form of transparent substrate shown at 1, and a light beam guided through it has an intensity distribution decreasing gradually to a critical angle θc(=sin⁻¹(1/n)) that is determined by the refractive index n of the light-guidance plate 1 on both its front and back surface sides, centering on a center plane 1′ including the center of an entrance end 15 of the light-guidance plate 1 and parallel with the plane of the light-guidance plate 1, as illustrated in FIG. 29. In other words, a light beam incident from an illumination light source such as a rod-like light source on the entrance end 15 of the light-guidance plate 1 has an intensity distribution 3 of nearly cos shape on both the front and back sides, centering on that center plane 1′. As the light beams enters the light-guidance plate 1, however, it is converted into a light beam having a distribution within an angle of ±θc according to Snell's law. When the refractive index n of the light-guidance plate 1 is 1.49 or an index of acrylic resin, θc≈42.160.

Thus, the light beam having a distribution centering on the center plane 1′ is guided toward the front surface side of the light-guidance plate 1, leaving it as backlight having a symmetric distribution. To this end it is needed to provide the back surface of the light-guidance plate 1 with V-grooves or grooves 21 of quadrangular cone shape including slants 20 having an angle of nearly ±45° with respect to the center plane 1′, so that the light beam is guided by reflection toward the front surface side of the light-guidance plate 1. However, when the refractive index n of the light-guidance plate 1 is 1.49, light beams from an angle range I where an angle range (−42.16° to 0°) for incidence of light from below the center plane 1′ is added to a slight angle range (0 to ±2.84°) for incidence of light above the center plane 1′ are guided by total reflection at the slant 20 toward the front surface side of the light-guidance plate 1, as indicated by some specific values in FIG. 29. However, nearly all of a light beam (0° to ±42.16°), which is incident from above the center plane 1′ and from within an angle range II (+2.84° to +42.16°) minus the above slight angle range (0 to +2.84°), passes through the slant 20 and gives out useless light 7 or stray light 8 making no contribution to illumination and rendering illumination efficiency worse, because of having an angle smaller than the critical angle θc.

In this case, the intensity of the light beam leaving the front surface of the light-guidance plate 1 has such an angle distribution as shown in FIG. 30. Here the exit angle of 0° lies in the frontal (normal) direction of the front surface side of the light-guidance plate 1, with a positive angle lying in the right-upper direction and a negative angle lying in the left-upper direction of FIG. 29. As can be seen from FIG. 30, the intensity distribution of backlight loses symmetry with respect to the frontal direction; that is, the illumination intensity on one side with respect to the front (the left side of FIG. 29) becomes nearly zero.

### SUMMARY OF THE INVENTION

In view of such situations as described above, a primary object of the invention is to provide a light-guidance plate for liquid crystal display backlights, which ensures frontally symmetric, bright illumination over a wide field angle.

According to the invention, the above object is accomplishable by the provision of a light-guidance plate used for a liquid crystal display backlight, characterized in that said light-guidance plate comprises a transparent plate substrate having a front surface, a back surface and an end face for introduction therein of illumination light from a light source, wherein said back surface is provided with V-grooves of V shape in section or quadrangular cone grooves, each comprising slants having an angle of ±(45°±5°) with respect to a center plane including a center of said entrance end and parallel with a plane of said plate substrate, with a direct-reflection layer provided on each slant.

Preferably in this invention, a portion of each V-groove or quadrangular cone groove at and near its vertex point should be formed into a curved portion having a radius of at least 2 μm or a flat portion of at least 2 μm in V-shaped section.

In one specific embodiment of the invention, the V-grooves or quadrangular cone grooves are arranged at a uniform density on one surface of the transparent plate substrate, and the thickness of the transparent plate substrate is distributed in such a smooth curved form that the luminance of light scattered toward the front surface side of the transparent plate substrate is substantially uniform across the front surface. In another specific embodiment of the invention, linear V-grooves or linearly aligned rows of quadrangular cone grooves are arranged on one surface of the transparent plate substrate, and the spacing between, and the depth of, the V-grooves or the rows of quadrangular cone grooves change in such a smooth way that the luminance of light scattered toward the front surface side of the transparent plate substrate is substantially uniform across the front surface.

In accordance with the invention wherein the back surface of the transparent plate substrate having a front surface, a back surface and an end face for the introduction of illumination light from a light source is provided with V-grooves of V shape in section or quadrangular cone grooves, each comprising slants having an angle of ±(45°±5°) with respect to a center plane including a center of said entrance end and parallel with a plane of said plate substrate, with a direct-reflection layer provided on each slant, it is possible to obtain a light-guidance plate for liquid crystal display backlights, which ensures frontally symmetric, bright illumination over a wide field angle.

Still other objects and advantages of the invention will in part be obvious and will in part be apparent from the specification.

The invention accordingly comprises the features of construction, combinations of elements, and arrangement of parts, which will be exemplified in the construction hereinafter set forth, and the scope of the invention will be indicated in the claims.

### BRIEF DESCRIPTION OF THE DRAWINGS

FIG. 1 is schematically illustrative in section of the light-guidance plate for liquid crystal display backlights according to the invention.

FIG. 2(a) is schematically illustrative in perspective of a V-groove of V shape in section, provided on the light-guidance plate, and FIG. 2(b) is schematically illustrative in perspective of a quadrangular cone groove provided on the light-guidance plate.

FIG. 3 is illustrative of an angle distribution of illumination light coming from the light-guidance plate of FIG. 1.

FIGS. 4(a), 4(b), 4(c) and 4(d) are illustrative in section of a curved, and a flat portion formed at and near the vertex point of a groove, and direct-reflection layers provided in the groove.

FIGS. 5(a) and 5(b) are front views of the light-guidance plates for flat light sources according to Examples 1 and 2 in JP(A)2004-227923, respectively.

FIG. 6 is illustrative of the light-emission intensity distribution of a linear light source in the longitudinal direction.

FIG. 7 is illustrative of the scattering coefficient distribution of the light-guidance plane according to Example 1 in JP(A)2004-227923.

FIG. 8 is illustrative of the thickness distribution of the light-guidance plate according to Example 1.

FIG. 9 is illustrative of a luminance distribution obtained on the front surface side of the light-guidance plate according to Example 1.

FIG. 10 is illustrative of a sectional shape, as taken on the X-axis, of the light-guidance plate according to Example 1.

FIG. 11 is illustrative of a sectional shape, as taken on the Y-axis, of the light-guidance plate according to Example 1.

FIG. 12 is illustrative of the scattering coefficient distribution of the light-guidance plane according to Example 2 in JP(A)2004-227923.

FIG. 13 is illustrative of the thickness distribution of the light-guidance plate according to Example 3.

FIG. 14 is illustrative of a luminance distribution obtained on the front surface side of the light-guidance plate according to Example 2.

FIG. 15 is illustrative of a sectional shape, as taken on the X-axis, of the light-guidance plate according to Example 2.

FIG. 16 is illustrative of a sectional shape, as taken on the Y-axis, of the light-guidance plate according to Example 6.

FIGS. 17(a) and 17(b) are a front view and a side view of the light-guidance plate for flat light sources according to Example 1 in Japanese Patent Application No. 2004-83916, respectively, and FIG. 17(c) is a partly enlarged view of that side view.

FIG. 18 is illustrative of the light-emission intensity distribution of a linear light source in the longitudinal direction.

FIG. 19 is indicative of the scattering coefficient distribution of the light-guidance plate according to Example 1.

FIG. 20 is indicative of the V-groove spacing (pitch) distribution of the light-guidance plate according to Example 1 in the X-axis direction.

FIG. 21 is indicative of the V-groove depth distribution of the light-guidance plate according to Example 1 in the Y-axis direction.

FIG. 22 is indicative of the luminance distribution of the light-guidance plate according to Example 1.

FIGS. 23(a) and 23(b) are a front view and a side view of the light-guidance plate for flat light sources according to Example 2 in Japanese Patent Publication No. 2004-83916, respectively, and FIG. 23(c) is a partly enlarged view of that side view.

FIG. 24 is illustrative of the light-emission intensity distribution of a linear light source in the longitudinal direction.

FIG. 25 is indicative of the scattering coefficient distribution of the light-guidance plate according to Example 2.

FIG. 26 is indicative of the V-groove spacing (pitch) distribution of the light-guidance plate according to Example 2 in the X-axis direction.

FIG. 27 is indicative of the V-groove depth distribution of the light-guidance plate according to Example 2 in the Y-axis direction.

FIG. 28 is indicative of the luminance distribution of the light-guidance plate according to Example 2.

FIG. 29 is schematically illustrative of a light-guidance plate for backlights, with only V-grooves located thereon.

FIG. 30 is indicative of the angle distribution of illumination light coming from the light-guidance plate of FIG. 29.

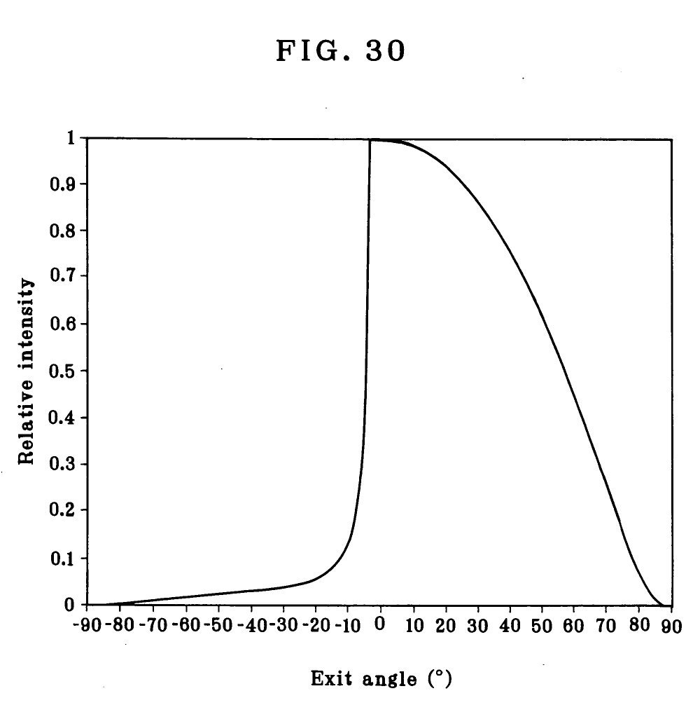

### DESCRIPTION OF THE PREFERRED EMBODIMENTS

The principles, and the preferred embodiments, of the invention will now be explained.

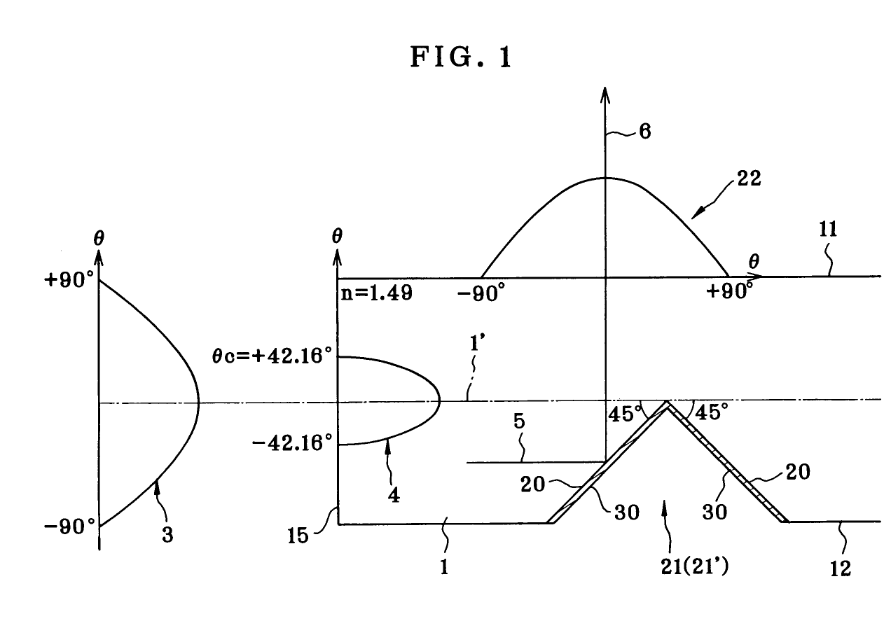

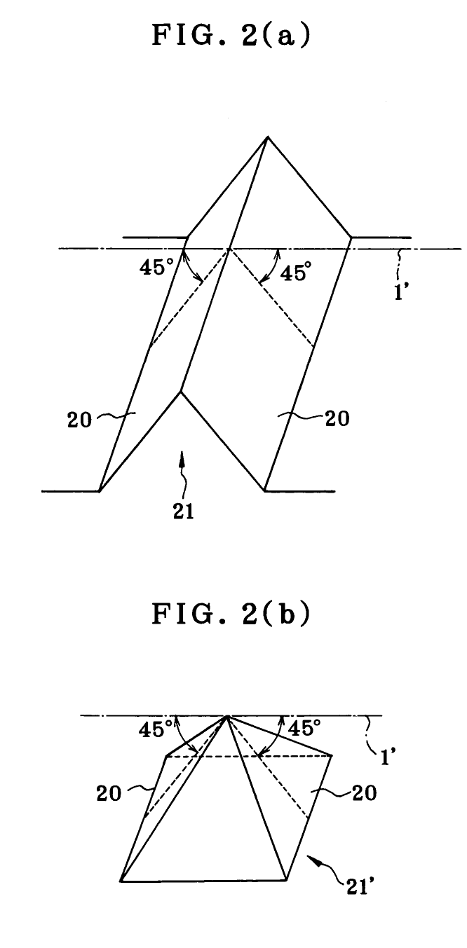

FIG. 1 is schematically illustrative in section of a light-guidance plate for liquid crystal display backlights according to the invention. A light-guidance plate 1 is formed of a plate form of transparent plate substrate comprising an entrance end 15 for the introduction therein of illumination light from an illumination light source such as a rod-like light source, a front surface 11 and a back surface 12. In that back surface 12, there is provided a V-groove 21 of V shape in section (FIG. 2(a)) or a quadrangular cone groove 21′ (FIG. 2(b)) having slants 20 and 20 of substantially ±45° with respect to a center plane 1′ including the center of the entrance end 15 and parallel with the plane of the light-guidance plate 1. A direct-reflection layer 30 is formed on the slant 20, 20.

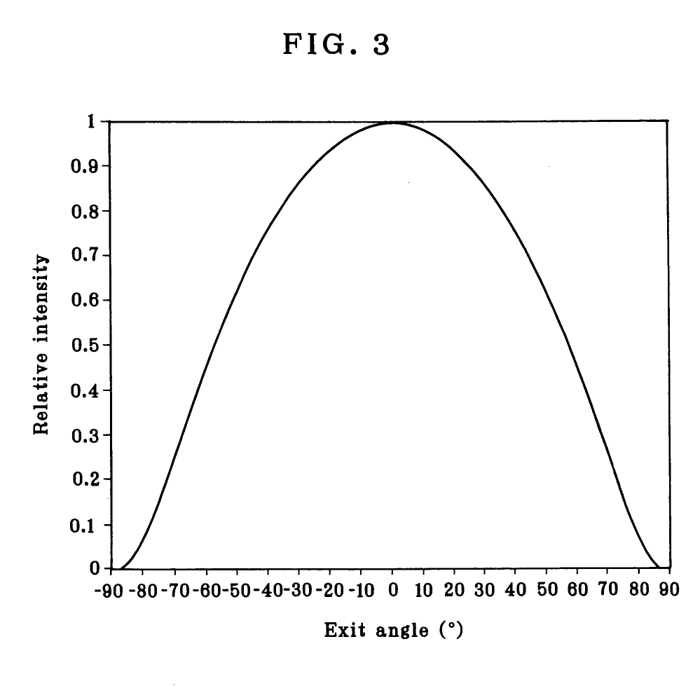

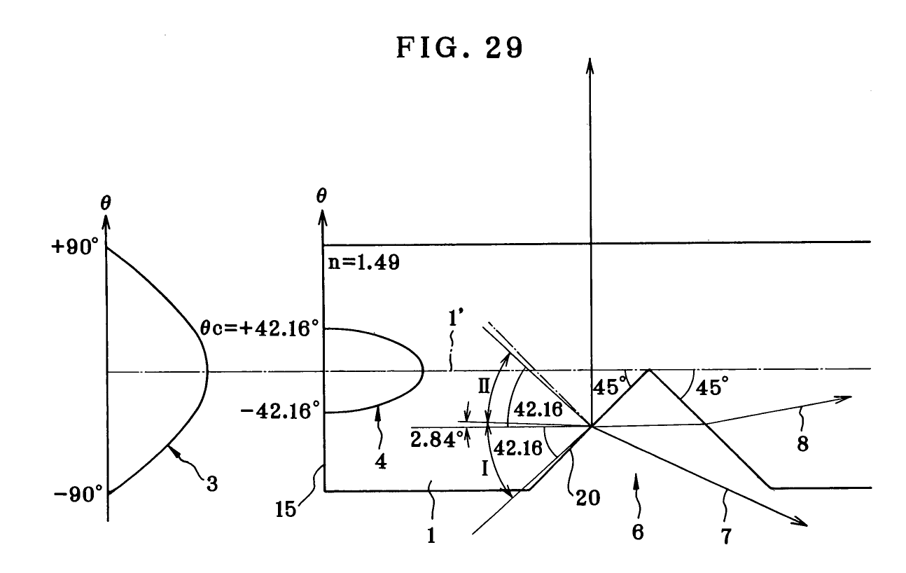

As an illumination light beam coming from an illumination light source like a rod-like light source with an intensity distribution 3 of substantially cos shape is incident on the entrance end 15 of the light-guidance plate 1, it is entered into the light-guidance plate 1 where it is converted into a light-guidance beam 5 having an intensity distribution 4 within an angle of ±θc. Then, this light-guidance beam 5 strikes on the slants 20 and 20 of the V-groove 21 (FIG. 2(a)) or the quadrangular cone groove 21′ (FIG. 2 (b)). The incident light, even when having an angle of incidence smaller than a critical angle θc, is all reflected by the direct-reflection layers 30 formed on the slants 20 and 20 in the frontal direction without giving rise to a transmitted light beam such as a light beam 7 or 8 in FIG. 29. The reflected light beam is incident on the front surface 11 while the same angle distribution as the intensity distribution 3 is maintained (but the center direction is bent 90°). Finally, the incident light beam, now in the form of an illumination light beam 6 having an angle distribution 22 within ±90° according to Snell's law (FIG. 1), leaves that front surface 11 in a frontally symmetric direction. In FIG. 3, the exit angle of 0° lies in the frontal direction of the front surface of the light-guidance plate 1 (the normal direction). As can be seen from FIG. 3, the backlight intensity distribution according to this embodiment is symmetric with respect to the frontal direction, and useless light is not generated at the slants 20 and 20 at all, ensuring that bright illumination light is obtainable avoiding wasting light. The angle distribution 22 of exit light in FIG. 3 has the same shape as the angle distribution 3 of the illumination light incident on the entrance end 15; with the use of a cathode ray tube for illumination, for instance, the illumination light emanating from the light-guidance plate 1, too, has a distribution of substantially cos shape. Thus, the instant embodiment is best suited for use as a backlight guidance plate for wide-field-angle liquid crystal displays.

Here each direct-reflection layer 30, for instance, could be formed by any suitable method inclusive of (1) formation of a reflecting film of aluminum, silver or other metal by vapor deposition or sputtering, (2) coating of a coating material containing aluminum, sliver or other metal particles (especially dish-like metal particles) while the metal particles are oriented parallel with a film surface), (3) deposition of a metal film by electro-less plating such as silver mirror reaction, and (4) deposition of a dielectric multilayer film by vapor deposition or the like.

It is noted that the angle of the V-groove 21 (FIG. 2(a)) or the quadrangular cone groove 21′ (FIG. 2(b)) with respect to the center plane 1′ of the slant 20, 20 is not always limited to ±45°, and so could be chosen from within the range of ±(45±5°).

In this regard, the V-groove 21 or the quadrangular cone groove 21′ having a vertex angle of nearly 90° is formed at a depth of usually about 10 μm. However, it is practically not easy to form the direct-reflection layer 30 all over such groove 21 or 21′, including its vertex point area. For instance, there are often some defects such as the absence of the direct-reflection layer 30 at and near the vertex point, and defective adherence of the direct-reflection layer 30 to the slants 20 and 20. Such defects may otherwise give rise to bright and dark spots, resulting in not only damage to uniform and bright illumination but also a drop of illumination efficiency.

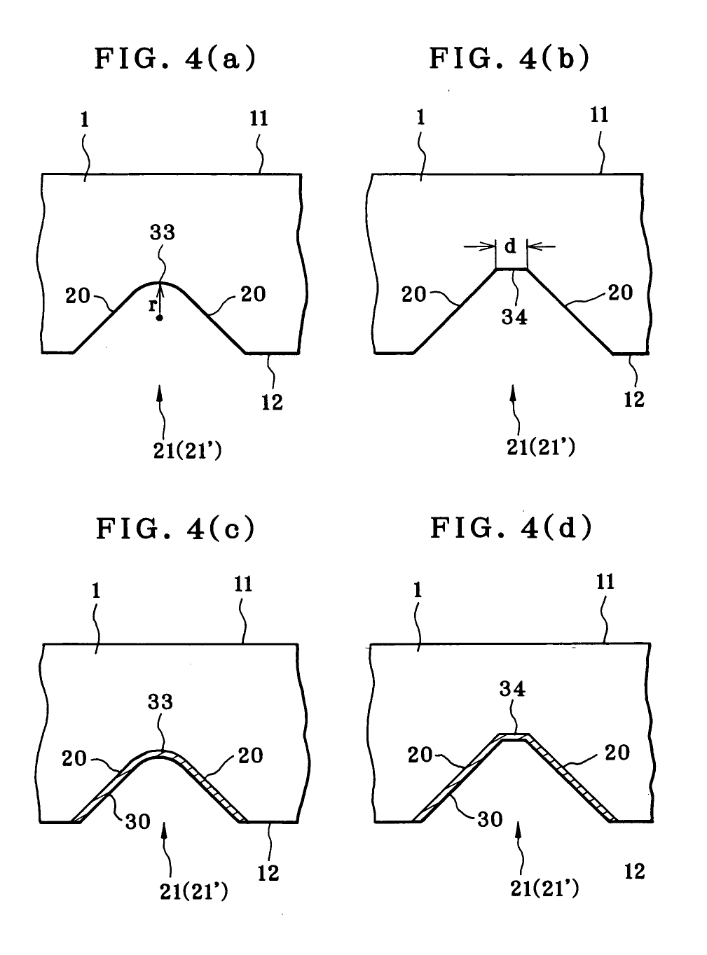

To avoid such defects, a portion of groove 21 or 21′ at and near the vertex point where the slants 20 and 20 come together is formed into a curved shape 33 having a radius r in the V-shaped section (as shown in FIG. 4(a)) or, alternatively, into a flat shape 34 having a length d (as shown in FIG. 4(b)). To this end, the radius r and the length l should be each at least 2 mm. With the provision of such a curved portion 33 or flat portion 34 at and near the vertex point of groove 21 or 21′, it is possible to form the defect-free direct-reflection layer 30 uniformly all over the slants 20 and 20 of groove 21 or 21′ including the curved portion 33, and the flat portion 34, as can be seen from the sectional views of FIGS. 4(c) and 4(d).

By the way, the inventor has filed Japanese Patent application No. 2003-14428 (JP(A)2004-227923) to come up with such a light-guidance plate for flat light sources as given below.

(1) A light-guidance plate for flat light sources used as a surface form of light source, which comprises a transparent plate substrate such that light from a light source located facing one end face of a periphery thereof is entered in the transparent plate substrate from the end face facing the light source, and light guided through internal reflection is scattered by a scatterer source located on one surface of the transparent plate substrate toward a front surface side of the transparent plate substrate, leaving the transparent plate substrate, characterized in that:

said scatterer source is located at a uniform density on the one surface of said transparent plate substrate, and said transparent plate substrate has a smoothly curved form of thickness distribution such that the light scattered toward the front surface side of said transparent plate substrate has a substantially uniform surface luminance.

(2) The light-guidance plate for flat light sources according to (1) above, characterized in that said transparent plate substrate is in a rectangular shape with a linear light source located facing one side thereof, wherein a thickness of said transparent plate substrate in a direction orthogonal to said linear light source becomes small with distance from said linear light source yet with a decreasing rate of change while a curve indicative of that thickness is upwardly concave and smooth, and a thickness of said transparent plate substrate in a direction along said linear light source reaches a maximum substantially at a center and decreases toward both ends, at least in a position of a side opposite to the side facing said linear light source while a curve indicative of that thickness is upwardly convex and smooth.

(3) The light-guidance plate for flat light sources according to (1) above, characterized in that said transparent plate substrate is in a rectangular shape with linear light sources located facing opposite sides thereof, wherein a thickness of said transparent plate substrate in a direction orthogonal to said linear light sources becomes small with distance from said linear light sources yet with a rate of change thereof decreasing and reaching a minimum of 0 substantially at a center of both sides while a curve indicative of that thickness is upwardly concave and smooth, and a thickness of said transparent plate substrate in a direction along said linear light sources reaches a maximum substantially at a center and decreases toward both ends, at least substantially in a center position between said linear light sources while a curve indicative of that thickness is upwardly convex and smooth.

(4) The light-guidance plate for flat light sources according to any one of (1) to (3) above, characterized in that said scatterer source is located at a uniform density on the back surface of said transparent plate substrate, and the back surface of said transparent plate substrate comprises a plane and the front surface of said transparent substrate comprises a curved surface.

The above V-grooves 21 (FIG. 2(a)) or the quadrangular cone groove 21′ according to the invention can be used as the scatterer source located at a uniform density on one surface of the transparent plate substrate proposed in JP(A)2004-227923. This in turn makes it possible to obtain a light-guidance plate for liquid crystal display backlights, which ensures frontally symmetric bright illumination over a wide field angle while achieving uniform surface luminance distribution and high efficiency of utilization of light. The invention is now explained with reference to some specific examples of JP(A)2004-227923.

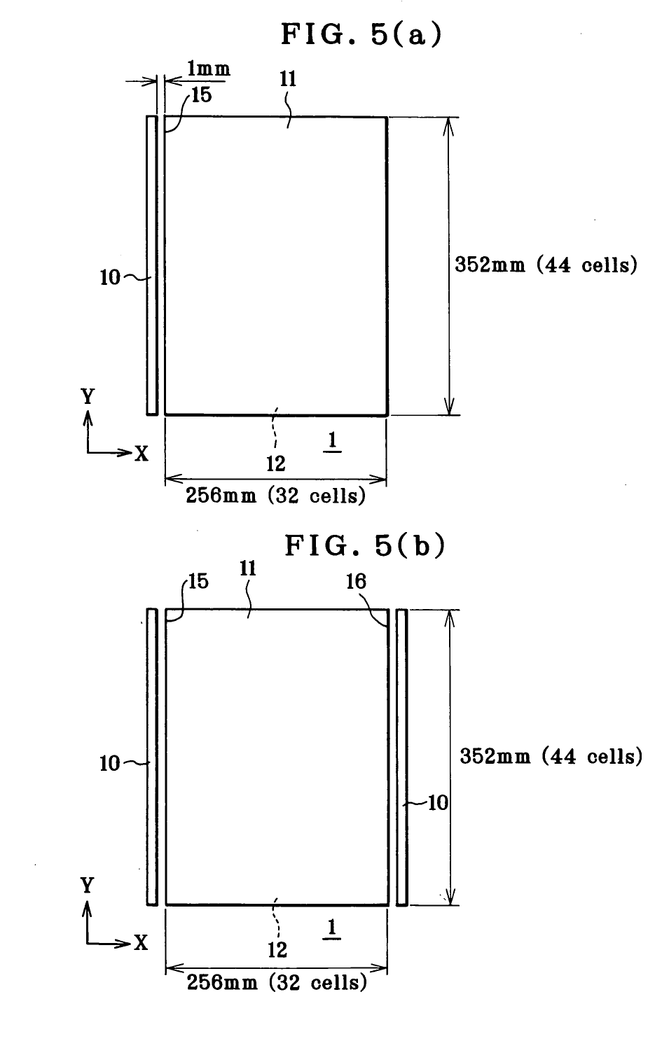

FIGS. 5(a) and 5(b) are front views of the light-guidance plate for flat light sources according to Examples 1 and 2 in JP(A)2004-227923.

Example 1 of FIG. 5(a) is directed to a rectangular light-guidance plate 1 having a side length of 256 mm in the X-direction and a side length of 352 mm in the Y-direction. A linear light source 10 having the same length as that of the long side of the light-guidance plate 1 is located facing one end face 15 on the long-side surface and spaced 1 mm-away therefrom. In calculation of the thickness distribution T(x, y) of the light-guidance plate 1, the light-guidance plate 1 is divided into 32 equal cells in the X-axis direction and 44 equal cells in the Y-axis direction. In the back surface 12, there is cut a uniform arrangement of scatterers comprising inventive V-grooves 21 that extend from outside in the X- and Y-directions. Specifically, the V-grooves 21, each having a thickness of 10 μm in the plate-guidance plate 1, are provided at a repeating pitch of 222 μm in the X- and Y-directions.

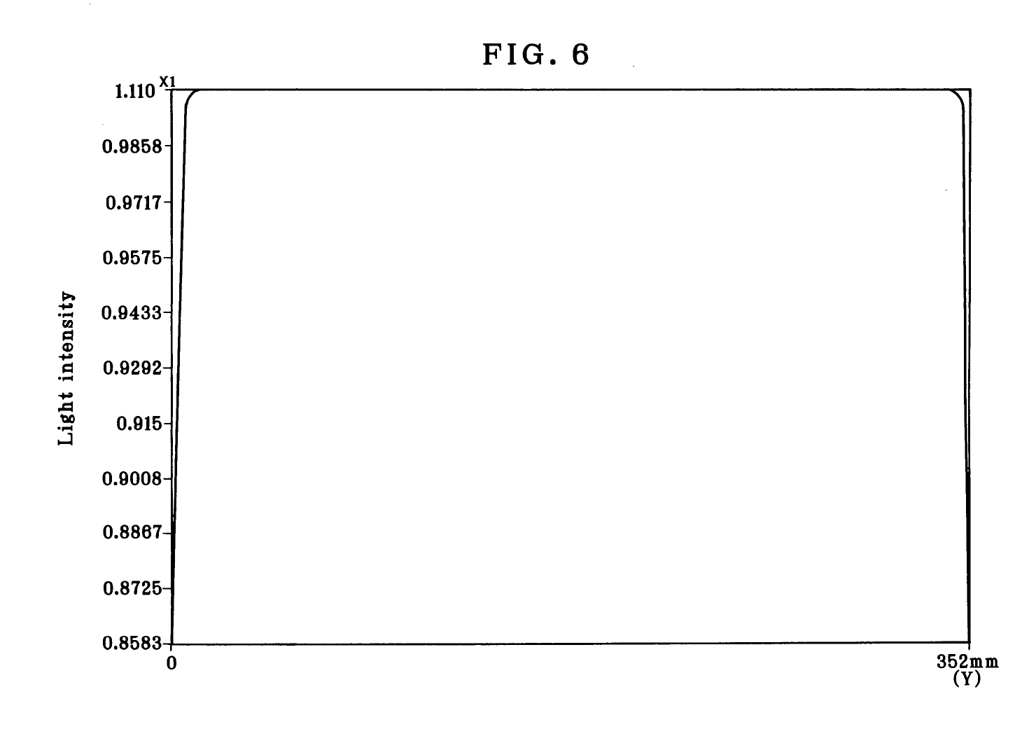

Here, the linear light source 10 has such a longitudinal light-emission intensity distribution as shown in FIG. 6, provided that the light intensity is normalized at 1.

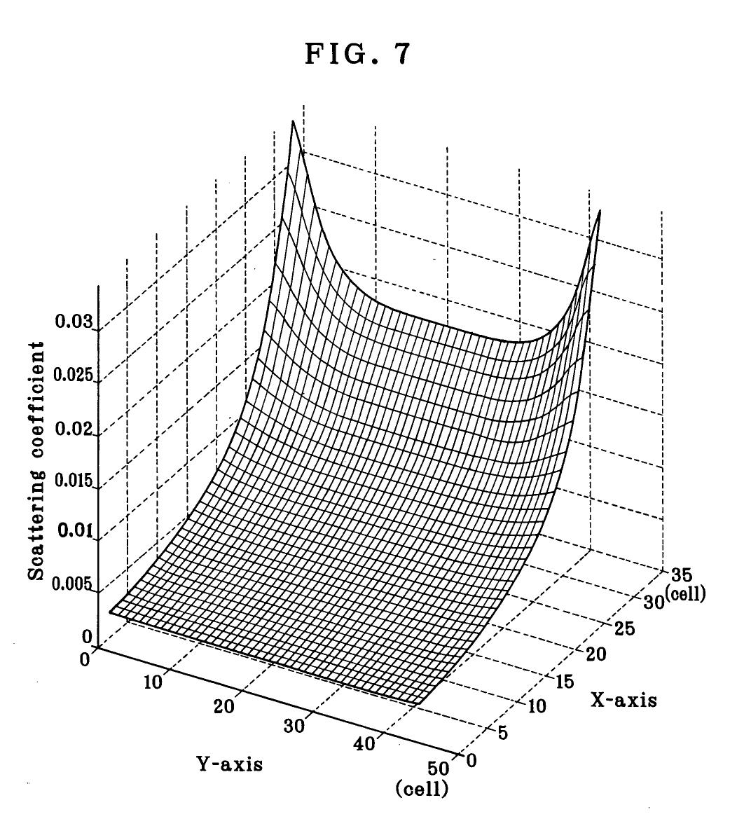

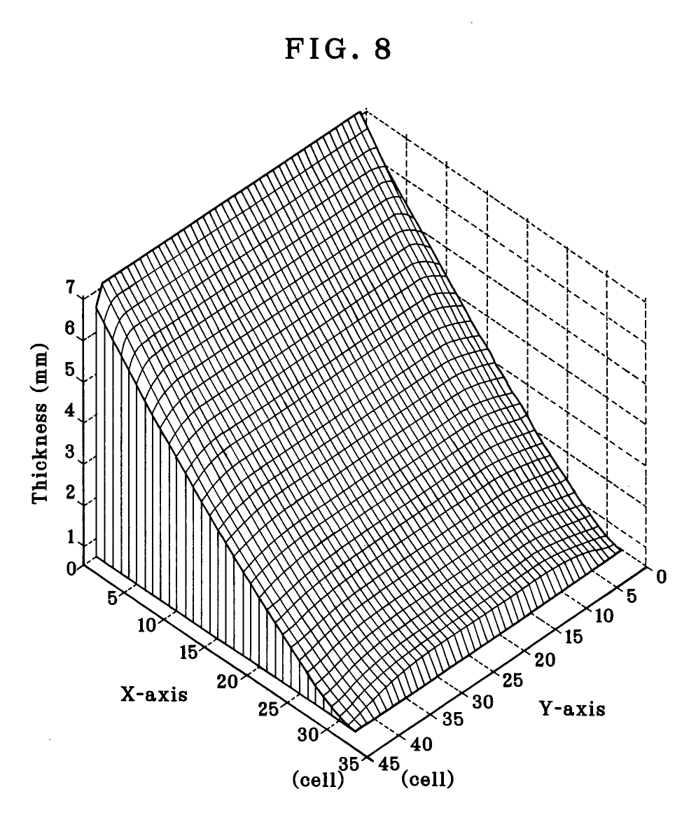

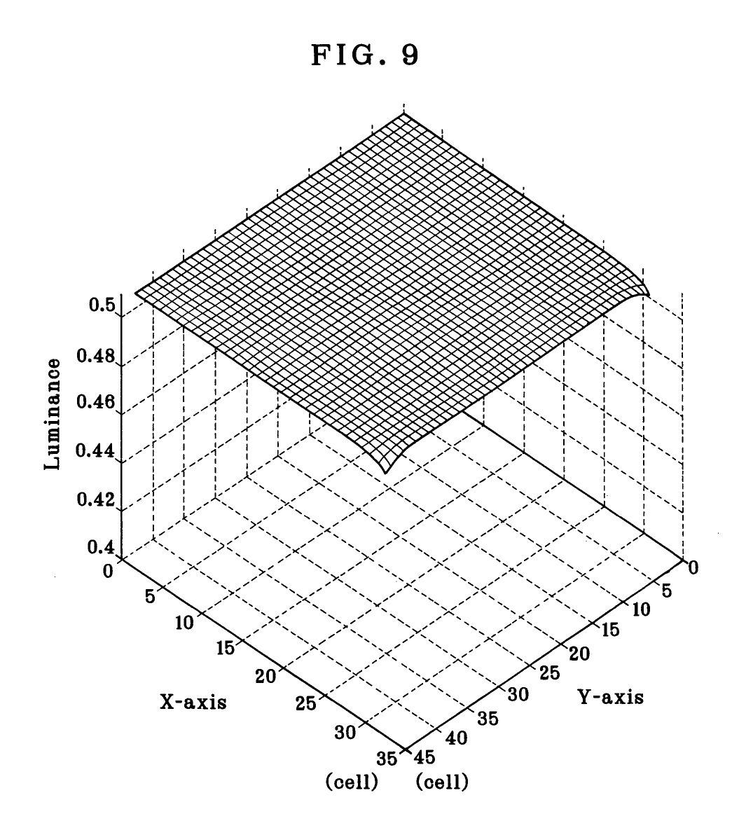

The light-guidance plate 1 according to Example 1 has such a scattering coefficient distribution F(x, y) as shown in FIG. 7, and the thickness distribution T(x, y) of the light-guidance plate 1, found therefrom, is in such a form as shown in FIG. 8. The luminance distribution, obtained on the front surface 11 side of the light-guidance plate 1 according to Example 1, is in such a form as shown in FIG. 9.

The obtained light-guidance plate 1 is found to have a surface variation of 0.45% and a scattering efficiency of 70.7%, indicating that it is possible to obtain a light-guidance plate for flat light sources that has a far more uniform surface luminance distribution and, hence, an ever higher efficiency.

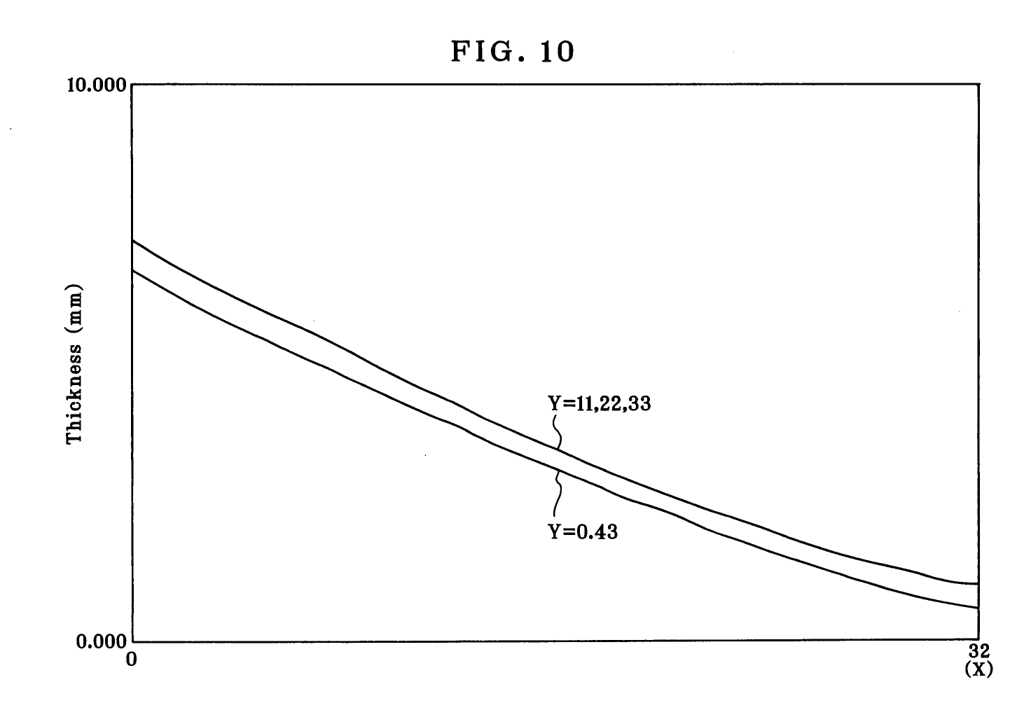

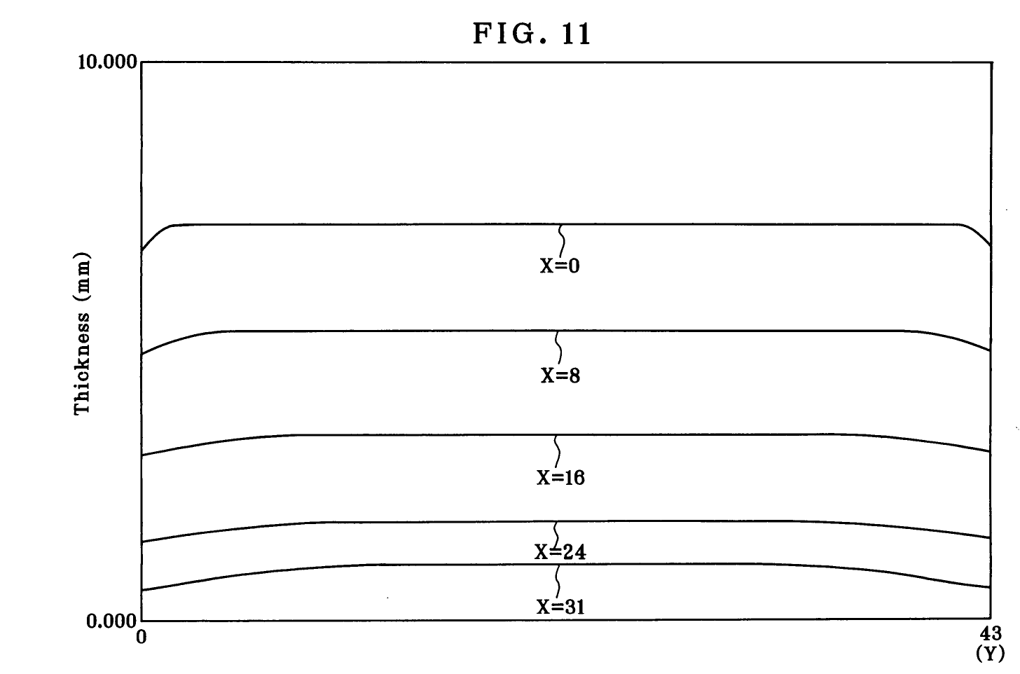

To specify the configuration of the obtained light-guidance plate 1, its sectional shapes taken on the X- and Y-axes are shown in FIGS. 10 and 11, respectively, wherein numerals indicative of positions in the X- and Y-directions are cell numbers as counted from one end of the plate 1.

From FIGS. 10 and 11, it can be seen that in the light-guidance plate 1 for flat light sources wherein, as exemplified in Example 1, the linear light source 10 is provided facing one side of a rectangular transparent plate substrate with a scatterer source located uniformly on one side thereof, its thickness in the direction orthogonal to the linear light source 10 (X-axis direction) becomes small with distance from the linear light source 10 yet with a decreasing rate of change while the curve indicative of that thickness is upward concave and smooth (FIG. 10), and its thickness in the direction along the linear light source 10 (Y-axis direction) reaches a maximum substantially at a center and decreases toward both ends even at any position in the direction orthogonal to the linear light source 10 while the curve indicative of that thickness is upwardly convex and smooth (FIG. 11). For instance, even when a light source that keeps uniform light-emission intensity unlikely to drop at both ends, as shown in FIG. 6, or a light source that is longer than the long sides of the light-guidance plate 1 is used as the linear light source 10, the curve indicative of its thickness in the direction along the linear light source 10 (Y-axis direction) is upward convex and smooth at least at a position of the other end face opposite to the end face 15 facing on the linear light source 10 side. It is noted that such shape is not limited to the specific one exemplified in Example 1.

Example 2 of FIG. 5(a) is directed to a rectangular light-guidance plate 1 having a side length of 256 mm in the X-direction and a side length of 352 mm in the Y-direction. Linear light sources 10, 10 having the same length as that of the long side of the light-guidance plate 1 are located facing one end faces 15, 16 on the long-side surface and spaced 1 mm-away therefrom. In calculation of the thickness distribution T(x, y) of the light-guidance plate 1, the light-guidance plate 1 is divided into 32 equal cells in the X-axis direction and 44 equal cells in the Y-axis direction. In the back surface 12, there is cut a uniform arrangement of scatterers comprising inventive V-grooves 21 that extend from outside in the X- and Y-directions. Specifically, the V-grooves 21, each having a thickness of 10 μm in the plate-guidance plate 1, are provided at a repeating pitch of 222 μm in the X- and Y-directions.

Here, the linear light source 10 has such a longitudinal light-emission intensity distribution as shown in FIG. 6, provided that the light intensity is normalized at 1.

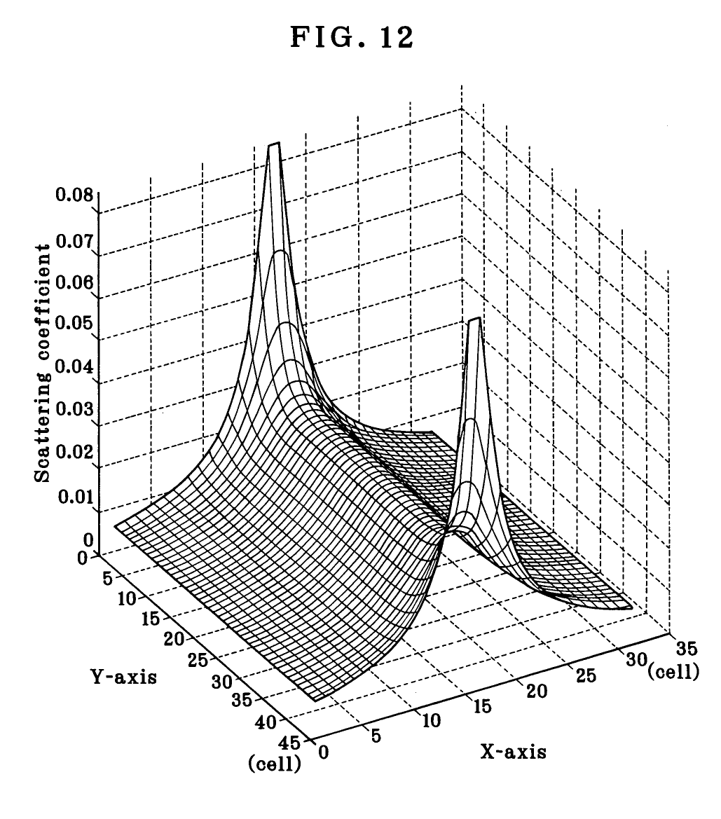

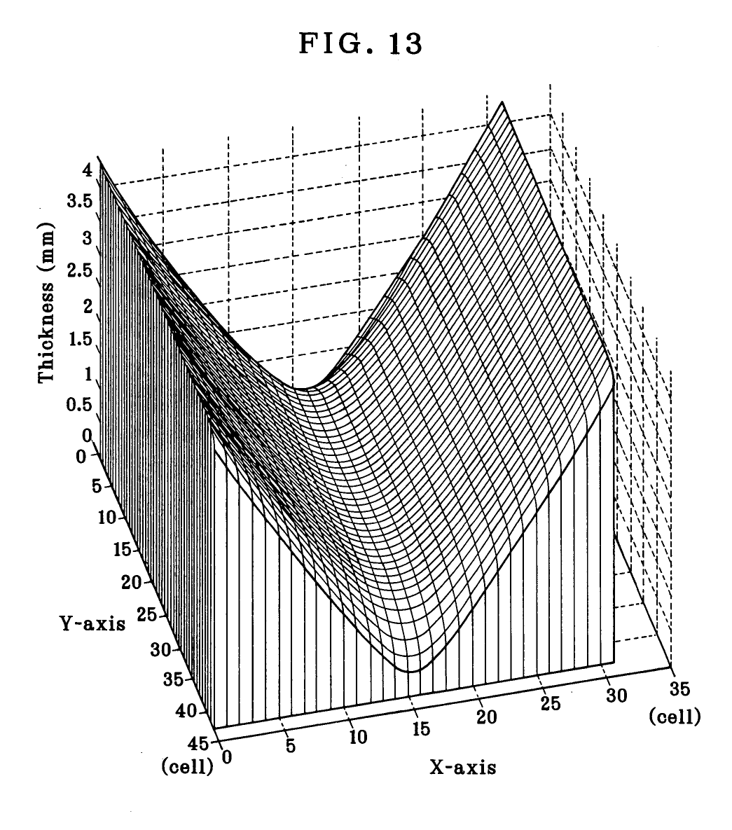

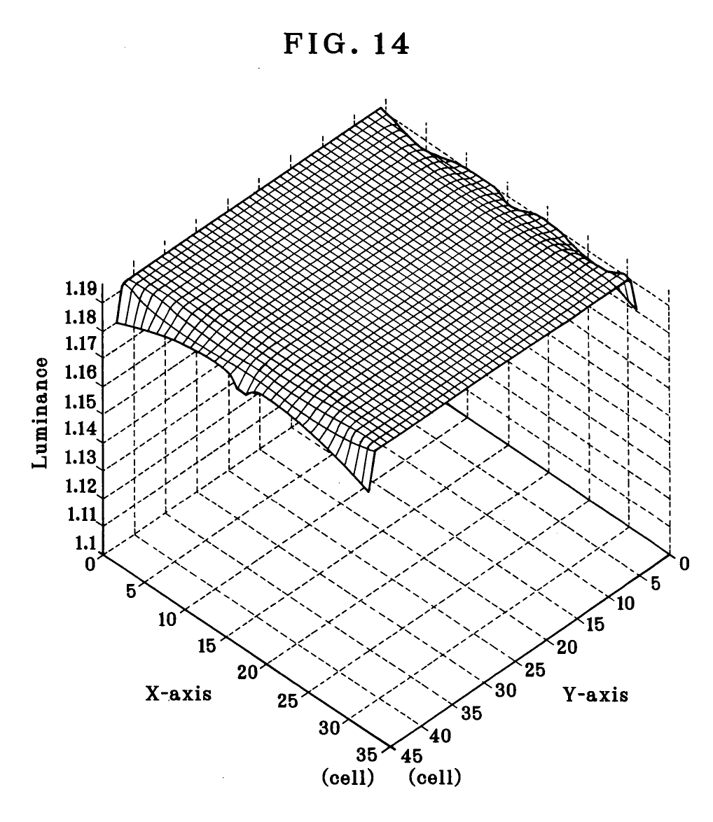

The light-guidance plate 1 according to Example 2 has such a scattering coefficient distribution F(x, y) as shown in FIG. 12, and the thickness distribution T(x, y) of the light-guidance plate 1, found therefrom, is in such a form as shown in FIG. 13. The luminance distribution, obtained on the front surface 11 side of the light-guidance plate 1 according to Example 2 is in such a form as shown in FIG. 14.

The obtained light-guidance plate 1 is found to have a surface variation of 0.435% and a scattering efficiency of 84.2%, indicating that it is possible to obtain a light-guidance plate for flat light sources that has a far more uniform surface luminance distribution and, hence, an ever higher efficiency.

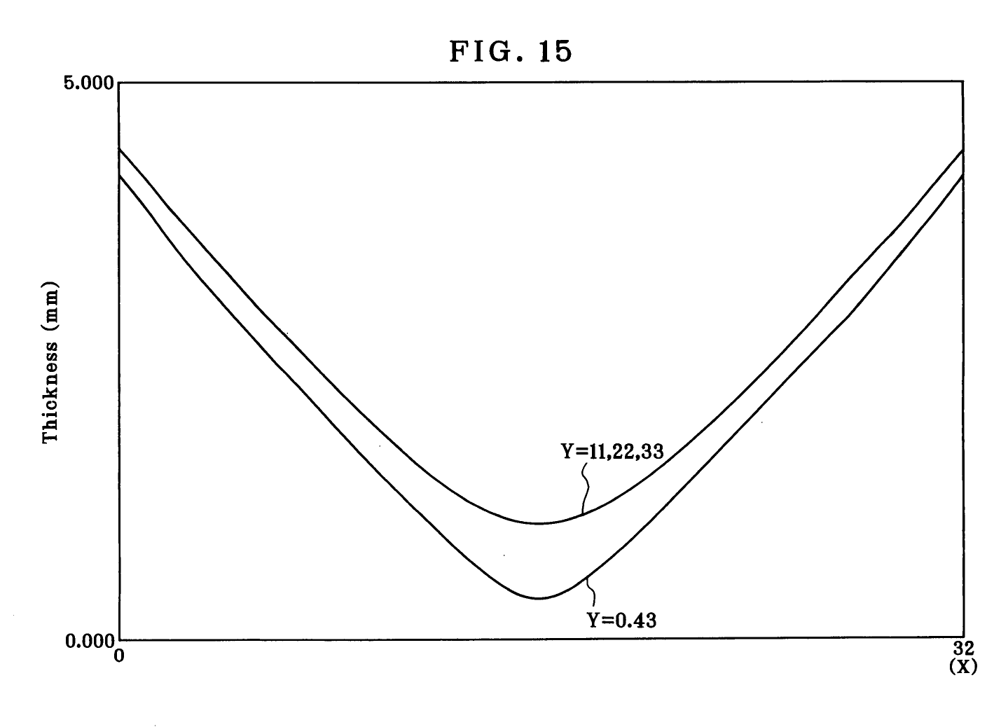

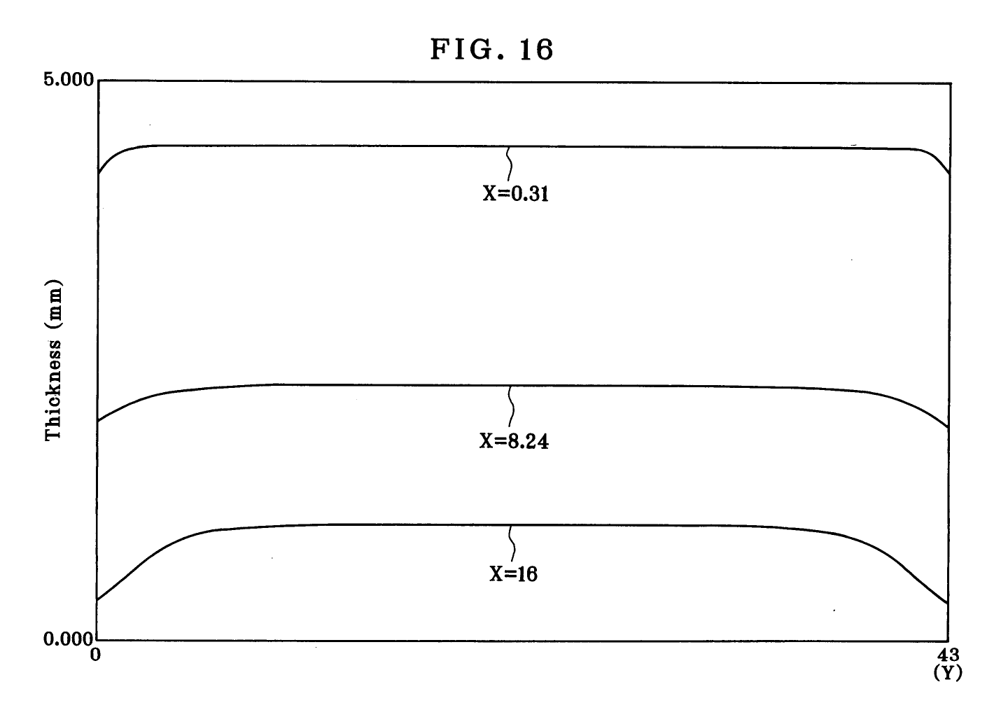

To specify the configuration of the obtained light-guidance plate 1, its sectional shapes taken on the X- and Y-axes are shown in FIGS. 15 and 16, respectively, wherein numerals indicative of positions in the X- and Y-directions are cell numbers as counted from one end of the plate 1.

From FIGS. 15 and 16, it can be seen that in the light-guidance plate 1 for flat light sources wherein, as exemplified in Example 2, the linear light sources 10 are provided facing both opposite sides of a rectangular transparent plate substrate with a scatterer source located uniformly on one surface thereof, its thickness in the direction orthogonal to the linear light sources 10 (X-axis direction) becomes small with distance from the linear light sources 10 yet with a decreasing rate of change and reaches a minimum substantially at the centers of both sides at the rate of change of 0 while the curve indicative of that thickness is upward concave and smooth (FIG. 15), and its thickness in the direction along the linear light sources 10 (Y-axis direction) reaches a maximum substantially at a center and decreases toward both ends even at any position in the direction orthogonal to the linear light sources 10 while the curve indicative of that thickness is upwardly convex and smooth (FIG. 16). For instance, even when a light source that keeps uniform light-emission intensity unlikely to drop at both ends, as shown in FIG. 6, or a light source that is longer than the long sides of the light-guidance plate 1 is used as the linear light sources 10, the curve indicative of its thickness in the direction along the linear light sources 10 (Y-axis direction) is upward convex and smooth at least at a center between the linear light sources 10. It is noted that such shape is not limited to the specific one exemplified in Example 2.

It is here noted that in either one of the light-guidance plates 1 as in Examples 1 and 2, too, the front surface 11 side or the back surface 12 side could be curved according to the thickness T(x, y) (with the other surface having a planar surface) or, alternatively, both the surfaces could be curved in such a way that their thicknesses change according to the thickness T(x, y). More preferably, the scatterer source is uniformly located on the planar back surface and the front surface is curved according to the thickness T(x, y), because plate fabrication is more facilitated.

While the above examples have been explained with reference to the use of the linear light source or sources 10, it is understood that even with the use of a point light source or the use of a plurality of point light sources instead of the linear light source, it is equally possible to obtain a light-guidance plate for flat light sources that has uniform surface luminance distribution and high efficiency of utilization of light.

The inventor has also filed Japanese Patent Application No. 2004-83916 to come up with such a light-guidance plate for flat light sources as recited below.

(1) A light-guidance plate for flat light sources used as a surface form of light source, which comprises a transparent plate substrate such that light from a light source located facing one peripheral end face thereof is entered in the transparent plate substrate from the end face facing the light source, and light guided through internal reflection is scattered by a scatterer source located on one surface of the transparent plate substrate toward a front surface side of the transparent plate substrate, leaving the transparent plate substrate, characterized in that:

said scatterer source on said one surface of said transparent plate substrate comprises linear grooves or rows of linearly aligned conical pits, and said grooves or rows of conical pits having a smoothly varying spacing and depth such that the light scattered toward the front surface side of said transparent plate substrate has a substantially uniform surface luminance.

(2) The light-guidance plate for flat light sources according to (1) above, characterized in that said transparent plate substrate is in a rectangular form with a linear light source located facing one side thereof, a plurality of said grooves or pit rows are located parallel with said one side, and said grooves or pit rows are positioned such that a spacing between said grooves or pit rows becomes small with distance from said linear light source and a curve indicative of a depth of each of said grooves or pit rows becomes minimum substantially at a center and increases toward both ends.

(3) The light-guidance plate for flat light sources according to (1) above, characterized in that said transparent plate substrate is in a rectangular form with linear light sources located facing opposite two sides thereof, a plurality of said grooves or pit rows are located parallel with said two sides, and said grooves or pit rows are positioned such that a spacing between said grooves or pit rows becomes small with distance from said linear light sources and reaches a minimum substantially at centers of said two sides and a curve indicative of a depth of each of said grooves or pit rows becomes minimum substantially at a center and increases toward both ends.

(4) The light-guidance plate for flat light sources according to any one of (1) to (3) above, characterized in that said transparent plate substrate has a thickness that varies along a length thereof.

By using the inventive V-grooves 21 (FIG. 2(a)) or quadrangular cone grooves 21′ (FIG. 2(b)) as the scatterer source located on one surface of a transparent plate substrate and comprising linear grooves or rows of linearly aligned conical pits as proposed in Japanese Patent Application No. 2004-83916, too, it is possible to obtain a light-guidance plate for liquid crystal display backlights, which ensures frontally symmetric, bright illumination over a wide field angle albeit having uniform surface luminance distribution and high efficiency of utilization of light. This is now explained with reference to two specific examples in Japanese Patent Application No. 2004-83916.

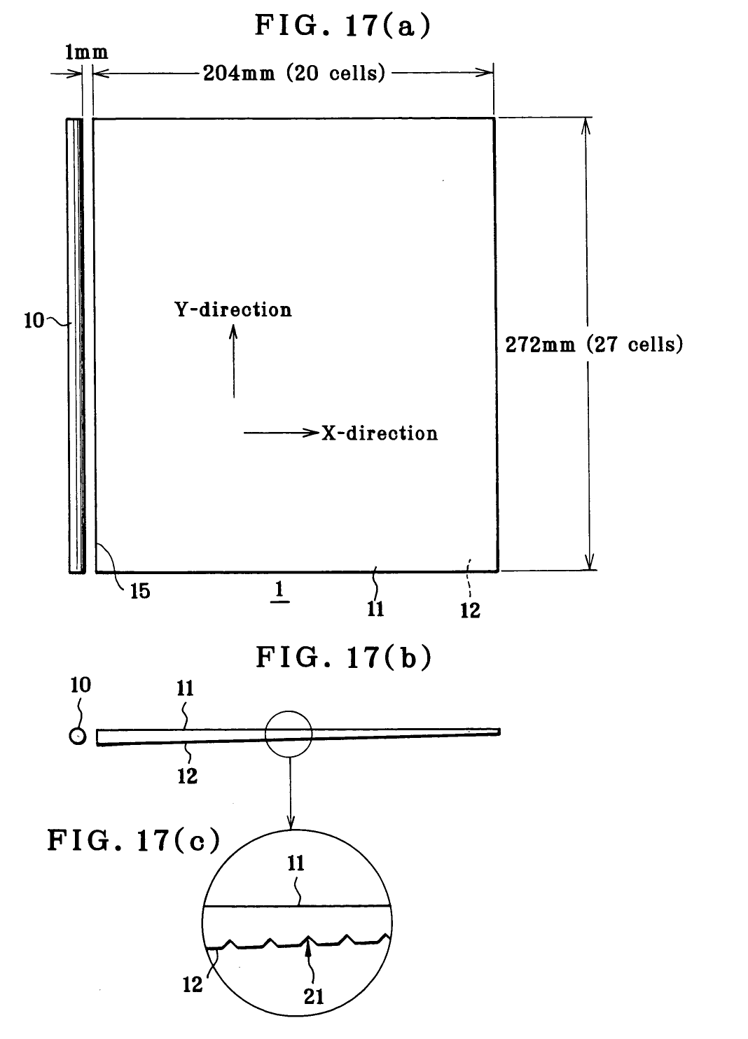

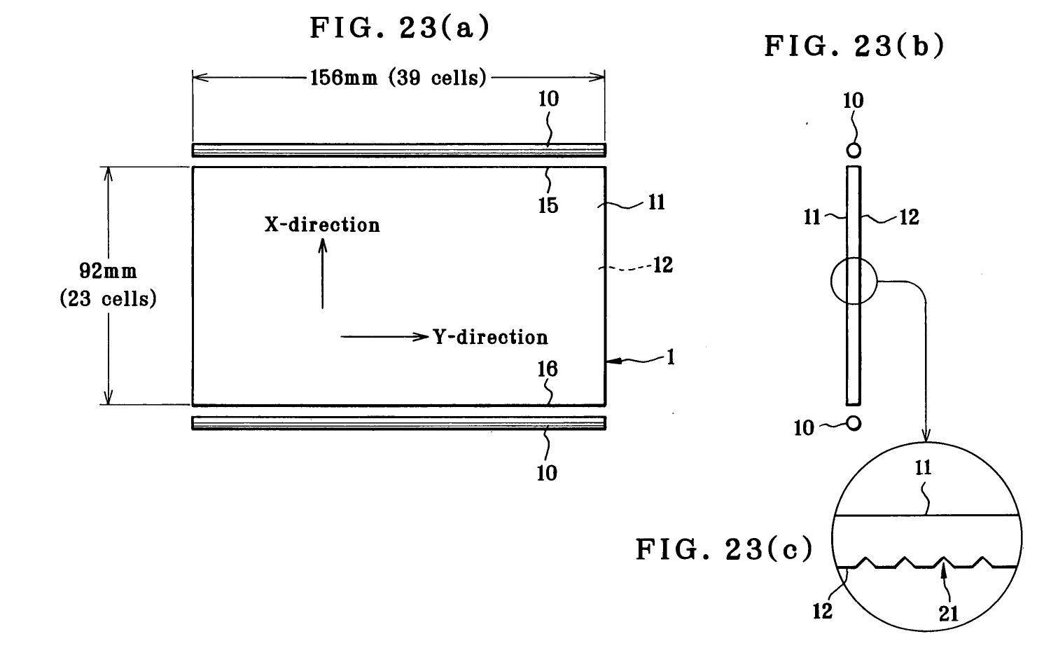

FIGS. 17(a) and 17(b) are a front view and a side view of the light-guidance plate 1 according to Example 1 in Japanese Patent Application No. 2004-83916, respectively, and FIG. 17(c) is a partly enlarged view of that side view. FIGS. 23(a) and 23(b) are a front view and a side view of the light-guidance plate 1 according to Example 2 in Japanese Patent Application No. 2004-83916, respectively, and FIG. 23(c) is a partly enlarged view of that side view.

In Example 1 of FIG. 17, there is provided a rectangular light-guidance plate 1 of 204 mm in the length of one side in the X-axis direction and 272 mm in the length of one side in the Y-axis direction. A linear light source 10 having the same length as the long side length of the light-guidance plate 1 is provided, facing one end face 15 of one long side thereof. Specifically, the linear light source 10 is spaced 1-mm away from one end face 15, and is configured into a wedge-like shape having a thickness decreasing from 2 mm on one end face 15 to 0.6 mm on the other end face. In calculation of the scattering coefficient distribution F(x, y) of the light-guidance plate 1, the light-guidance plate 1 is divided into 20 equal cells in the X-axis direction and 27 equal cells in the Y-axis direction. In the back surface 12 of the light-guidance plate 1 there are cut a multiplicity of parallel V-grooves 21 extending from outside in the Y-axis direction. Those V-grooves 21 have all a height of just 10 μm in the light-guidance plate 11 and at the center of the Y-axis direction, and the pitch between the V-grooves 21 extending in the Y-axis direction varies in the X-axis direction.

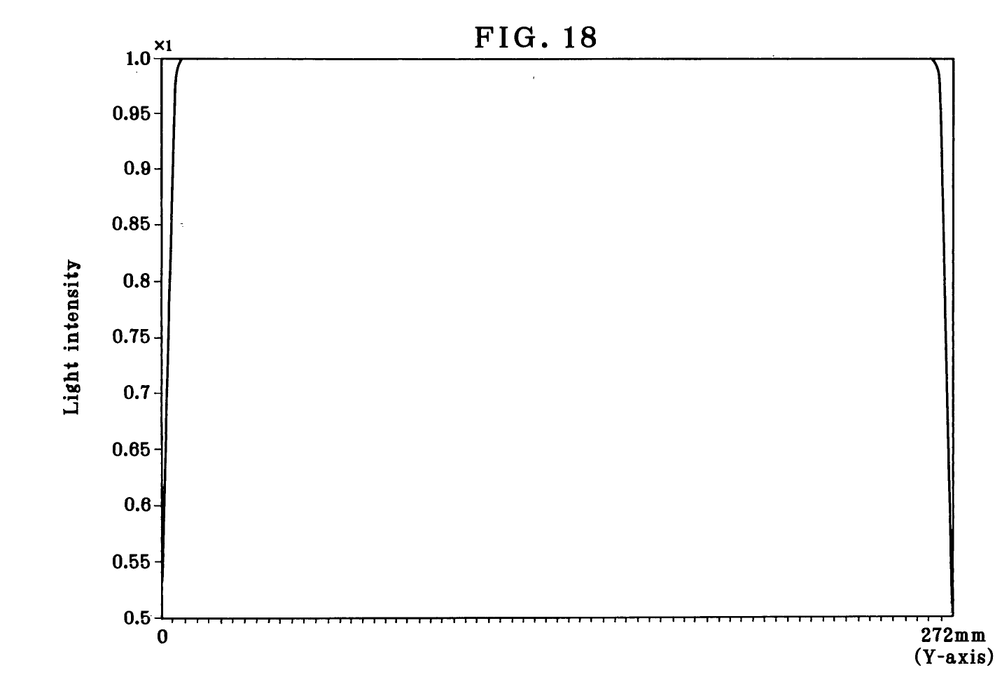

Here the linear light source 10 has such a longitudinal light-emission intensity distribution as shown in FIG. 18, provided that the intensity of light is normalized at 1.

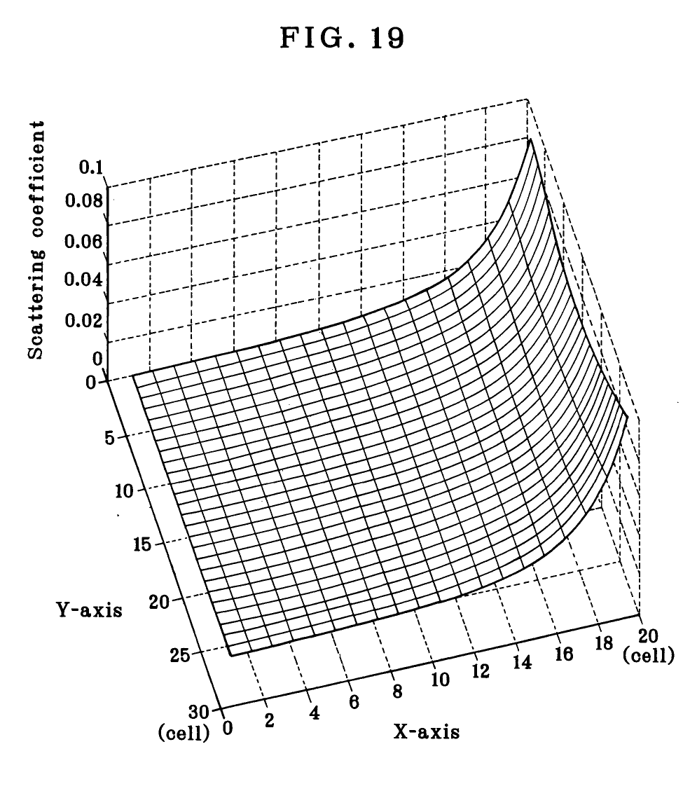

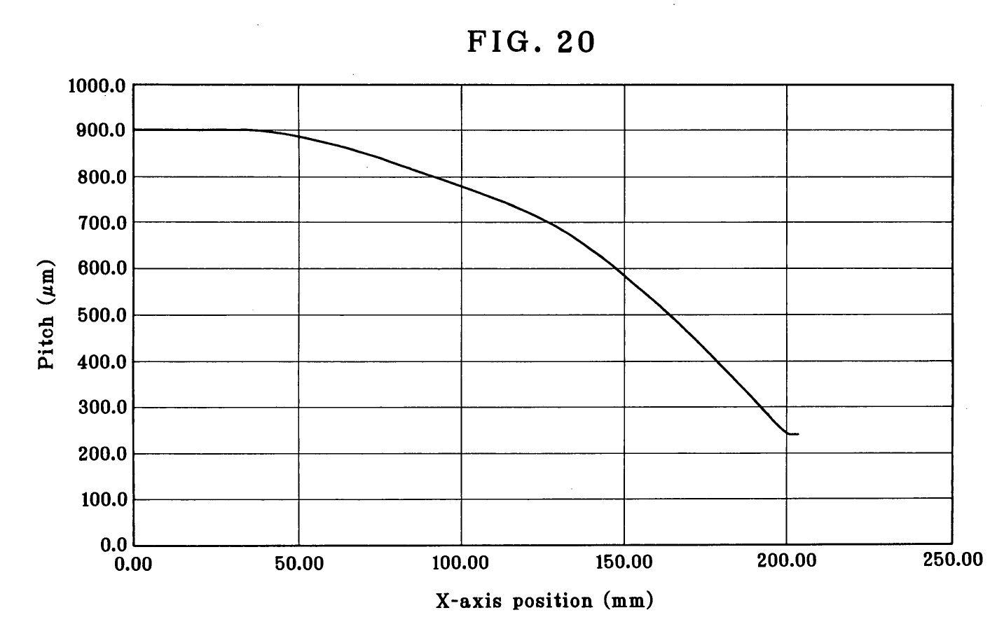

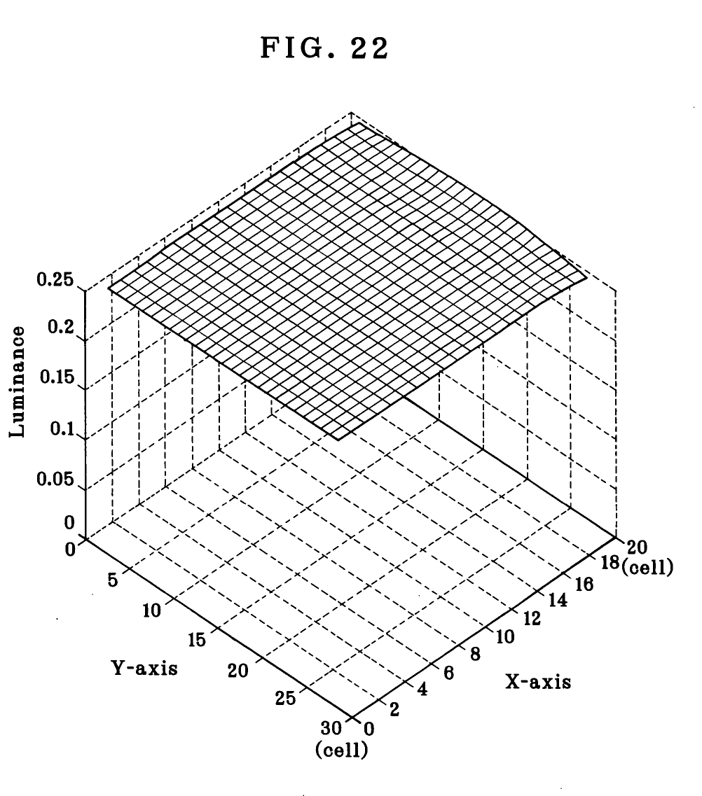

The light-guidance plate 1 of Example 1 has such a scattering coefficient distribution F(x, y) as shown in FIG. 19, the spacing (pitch) distribution of the V-grooves 21 in the X-axis direction, obtained therefrom, has such a form as shown in FIG. 20, and the depth distribution of each V-groove 21 in the Y-axis direction has such a form as shown in FIG. 22. The luminance distribution obtained on the front surface 11 side of the light-guidance plate 1 according to Example 1 has such a form as shown in FIG. 22. However, it is noted that in FIGS. 19, 21 and 22, the numerals indicative of positions in the X- and Y-axis directions are cell numbers.

The light-guidance plate 1 obtained according to Example 1 has a surface symmetry of 95% and a scattering efficiency of 75% or greater, indicating that the surface luminance distribution is extremely even and uniform. It is thus found that a light-guidance plate for flat light sources having an ever higher efficiency is obtainable according to the invention.

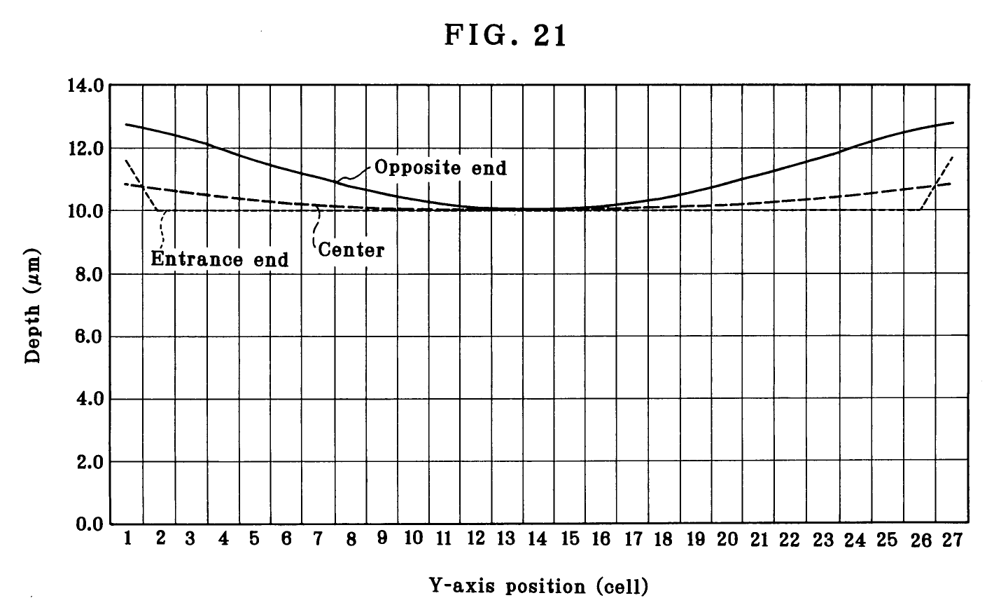

In this embodiment, the pitch between the V-grooves 21 becomes gradually small with distance from the linear light source 10, and the curve indicative of that pitch is upwardly convex and smooth, as can be seen from FIG. 20. The depth of each V-groove 21 becomes minimum substantially at the center even in any position on the X-axis and becomes large toward both ends, and the curve indicative of that depth is downwardly convex and smooth, as can be seen from FIG. 21. Each V-groove 21 becomes deeper at both ends than at the center with distance from the linear light source 10.

Referring then to Example 2 of FIGS. 23(a) and 23(b), there is provided a rectangular light-guidance plate 1 of 92 mm in the length of one side in the X-axis direction and 156 mm in the length of one side in the Y-axis direction. Linear light sources 10 and 10 having the same length as the long side length of the light-guidance plate 1 are provided, facing end faces 15 and 16 thereof. More specifically, the linear light sources 10 and 10 are spaced 1-mm away from the end faces 15 and 16, and are each made up of a plane-parallel plate having a uniform thickness of 5 mm along its length. In calculation of the scattering coefficient distribution F(x, y) of the light-guidance plate 1, the light-guidance plate 1 is divided into 23 equal cells in the X-axis direction and 39 equal cells in the Y-axis direction. In the back surface 12 of the light-guidance plate 1 there are cut a multiplicity of parallel V-grooves 21 extending from outside in the Y-axis direction. Those V-grooves 21 have all a height of just 50 μm in the light-guidance plate 11 and at the center of the Y-axis direction, and the pitch between the V-grooves 21 extending in the Y-axis direction varies in the X-axis direction.

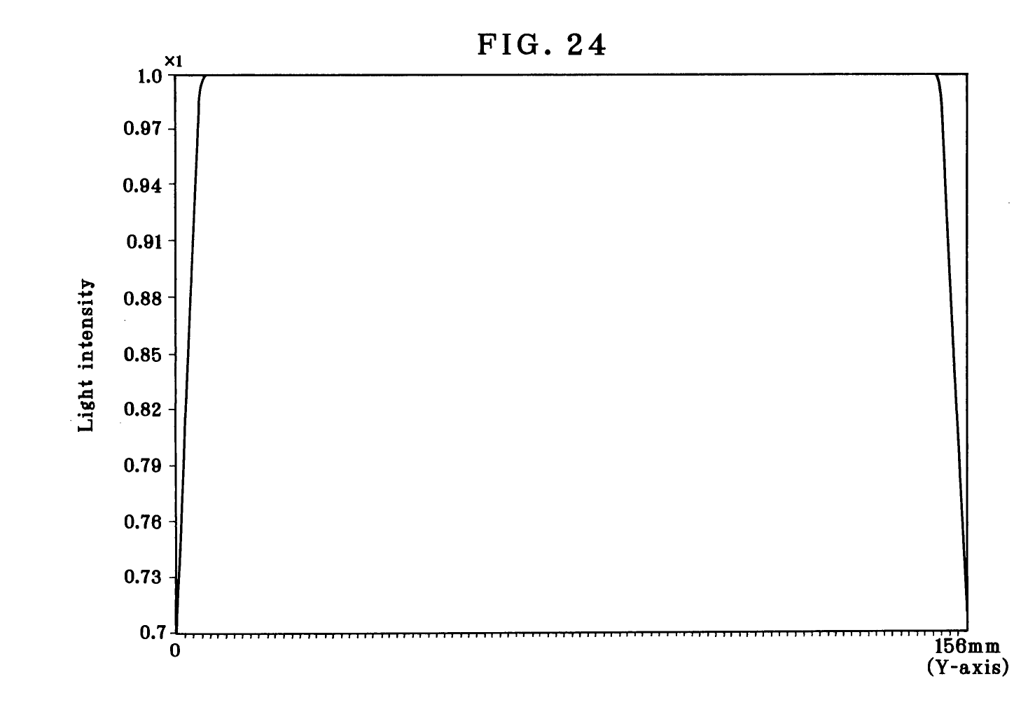

Here the linear light source 10 has such a longitudinal light-emission intensity distribution as shown in FIG. 24, provided that the intensity of light is normalized at 1.

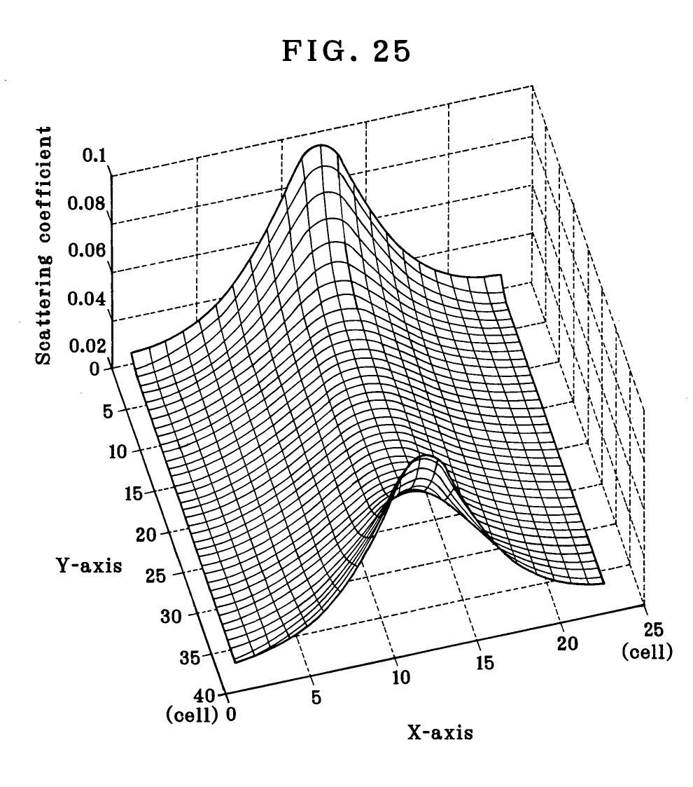

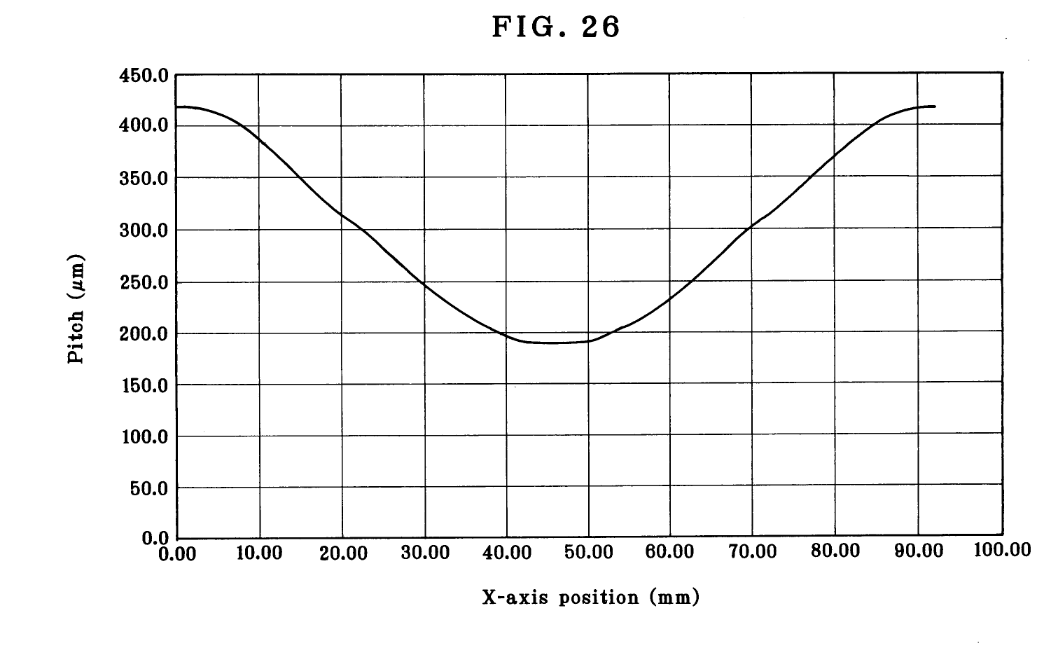

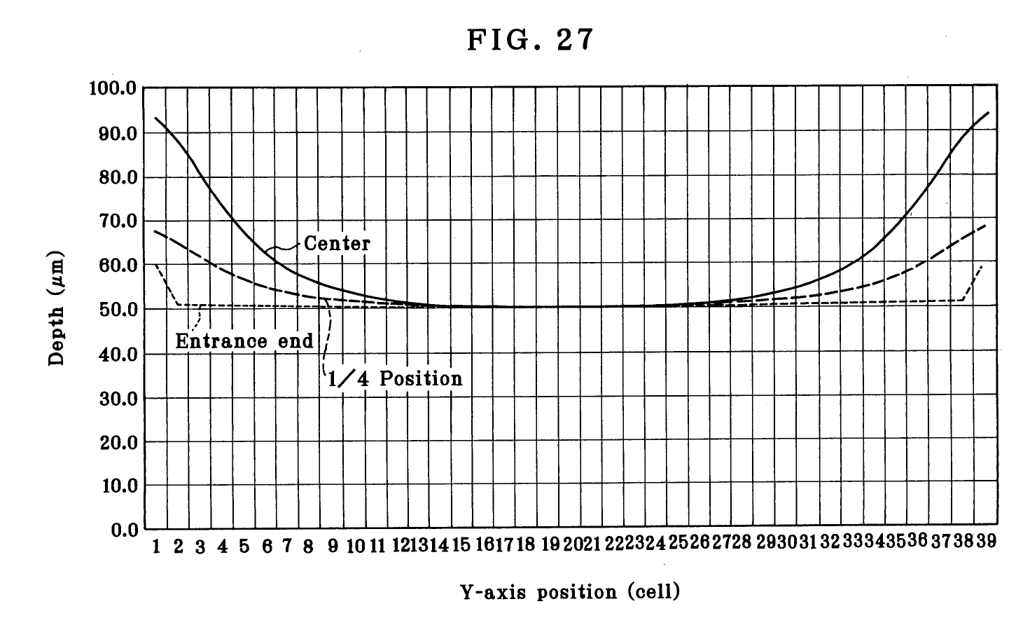

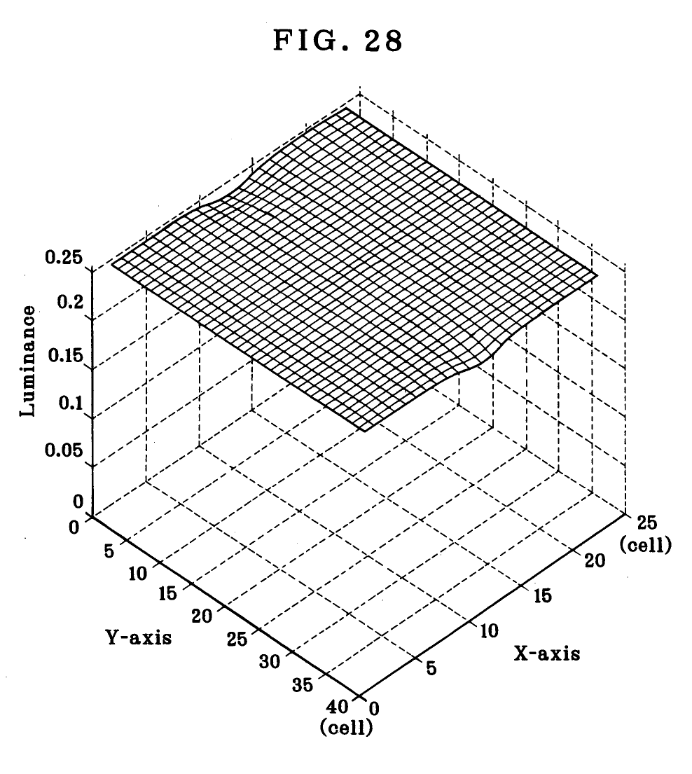

The light-guidance plate 1 of Example 2 has such a scattering coefficient distribution F(x, y) as shown in FIG. 25, the spacing (pitch) distribution of the V-grooves 21 in the X-axis direction, obtained therefrom, has such a form as shown in FIG. 26, and the depth distribution of each V-groove 21 in the Y-axis direction has such a form as shown in FIG. 27. The luminance distribution obtained on the front surface 11 side of the light-guidance plate 1 according to Example 2 has such a form as shown in FIG. 28. However, it is noted that in FIGS. 25, 27 and 28, the numerals indicative of positions in the X- and Y-axis directions are cell numbers.

The light-guidance plate 1 obtained according to Example 2 has a surface symmetry of 95% and a scattering efficiency of 80% or greater, indicating that the surface luminance distribution is extremely even and uniform. It is thus found that a light-guidance plate for flat light sources having an ever higher efficiency is obtainable according to the invention.

In this embodiment, the pitch between the V-grooves 21 becomes gradually small with distance from the linear light sources 10 and becomes minimum substantially at the centers of the end faces 15 and 16, and the curve indicative of that pitch is downwardly convex and smooth such that it has a minimum value substantially at the center between the points of inflection near the end faces 15 and 16, as can be seen from FIG. 26. The depth of each V-groove 21 becomes minimum substantially at the center even in any position on the X-axis and becomes large toward both ends, and the curve indicative of that depth is downwardly convex and smooth, as can be seen from FIG. 27. Each V-groove 21 becomes deeper at both ends than at the center with distance from the linear light sources 10 toward the centers of the end faces 15 and 16.

While the invention has been described with reference to the specific examples using the linear light source or sources 10, it is understood that when a point light source is used or a plurality of point light sources are used instead of the linear light source, too, it is possible to achieve a light-guidance plate for flat light sources, which has uniform surface luminance distribution and high efficiency of utilization of light.

While the light-guidance plate for liquid crystal display backlights according to the invention has been described with reference to its principles and specific examples, it is understood that the invention is never limited thereto, and so may be modified in various manners.

1. A light-guidance plate used for a liquid crystal display backlight, which comprises a transparent plate substrate having a front surface, a back surface and an end face for introduction therein of illumination light from a light source, wherein said back surface is provided with V-grooves of V shape in section or quadrangular cone grooves, each comprising slants having an angle of ±(45°±5°) with respect to a center plane including a center of said entrance end and parallel with a plane of said plate substrate, with a direct-reflection layer provided on each slant.

2. The light-guidance plate for a liquid crystal display backlight according to claim 1, wherein a portion of each V-groove or quadrangular cone groove at and near a vertex point thereof is formed into a curved portion having a radius of at least 2 μm or a flat portion of at least 2 μm in V-shaped section.

3. The light-guidance plate for a liquid crystal display backlight according to claim 1 or 2, wherein said V-grooves or quadrangular cone grooves are arranged at a uniform density on one surface of said transparent plate substrate, and a thickness of said transparent plate substrate is distributed in such a smooth curved form that a luminance of light scattered toward a front surface side of said transparent plate substrate is substantially uniform across said front surface.

4. The light-guidance plate for a liquid crystal display backlight according to claim 1 or 2, wherein linear V-grooves or linearly aligned rows of quadrangular cone grooves are arranged on one surface of said transparent plate substrate, and a spacing between, and a depth of, said V-grooves or said rows of quadrangular cone grooves changes in such a smooth way that a luminance of light scattered toward a front surface side of said transparent plate substrate is substantially uniform across said front surface.
